(19) United States
(12) Patent Application Publication
(10) Pub. No.: US 2007/0191110 A1
(43) Pub. Date: Aug. 16, 2007

(54) Data acquisition software implementation and scientific analysis methods for sports statistics and phenomena

(76) Inventor: Erick Van Allen Crouse, Hampton, VA (US)

Correspondence Address: Erick Van Allen Crouse, Apt. #4, 222 Regent St., Hampton, VA, 23669, US

(21) Appl. No.: 11/351,570

(22) Filed: Feb. 10, 2006

(51) Int. Cl. A63F 13/00

(52) U.S. Cl. 463/43

(57) ABSTRACT

This invention provides an innovative method for analyzing sports statistics and phenomenon by using quantized event data classes. Computerized algorithms can sift through the quantized event data structures resolving all recorded event attributes and also calculate innumerable statistical results based on those particular attributes.

### 1 REFERENCES CITED

U.S. Pat. No. 6,441,846 Aug. 27, 2002 Carlbom, et al. 348/91

U.S. Pat. No. 6,691,063 Feb. 10, 2004 Campbell, et al. 702/182

### 2 STATEMENT REGARDING FEDERALLY SPONSORED RESEARCH OR DEVELOPMENT

Applicable.

### 3 REFERENCE TO SEQUENCE LISTING, TABLE, OR A COMPUTER PROGRAM LISTING

Applicable.

### 4 BACKGROUND OF THE INVENTION

We discuss the traditional statistical approach, the game from a scientific perspective, and finally current practices for gathering statistics from a game and why these current methods do not yield the fascinating statistical analysis that the current invention provides. This invention not only focuses on the data acquisition, but also the subsequent analysis of the phenomenological data gathered from a sport contest.

4.1 Traditional Statistical Approach

The traditional statistical approach is the conventional way in which fundamental statistics are gathered and presented. Anyone who has witnessed an actual telecasted game, looked in the newspaper sports section, or watched a sports show dedicated to discussing statistics and formulating opinions should be very familiar with the traditional statistical breakdown. Analysts have a tendency to overanalyze these fundamental statistical quantities and base their opinions from speculation or from their own personal experiences and beliefs rather than from an empirical context. Their opinions often conflict with each other and in some instances their predictions are totally absurd which can be discouraging from the viewer's standpoint.

A few selected examples of seasonal (FIG. 1) and game statistics (FIG. 2) have been provided so that we can evaluate the overall effectiveness of the approach. The first and foremost assessment that can be made is that the statistics are intrinsically “static.” These quantities are tabulated in such a way that they remain independent of each other and all dynamical information is no longer attainable. Any relationships which may exist amongst the quantities are neglected and as result we cannot determine how the change of one statistic affects the others. Essentially all we have is a “snapshot” of the situation which only provides us with a summary of the game actions for some duration of time. Just about all we are permitted to do with these statistics is make comparisons between the teams and players contributions.

Another assessment is that the approach is deterministic. We know a priori what calculated quantities to expect from the final compilation of the recorded statistics. These statistical quantities are presented as box scores which reveal the general breakdown of statistics in terms of total points, rebounds, assists, etc. for both the teams and players. In addition some derived statistical quantities which can be obtained by performing some type of simple mathematical calculation on the data. By presenting the statistical information in terms of averages and percentages analysts can perceive the data in a normalized manner so that general statistical comparisons can be made.

These fundamental statistics have emerged throughout the history of the game and provide useful information about the players and decent summary of the game. However, these quantities along with their associated averages and percentages only provide very crude methods for trying to extract any detailed information. In some instances they may even be regarded as regressing one's understanding of the dynamical nature of the game. In the following sections we will begin to understand why these statistical quantities are insufficient and inadequate to provide a genuinely insightful analysis. A new concept for representing the statistics will be discussed enlightening us of some of the inherent deficiencies in the traditional system.

Upon doing a patent search in the related field a patent related to this invention has been granted. Here is an excerpt taken from U.S. Pat. No. 6,691,063 Campbell et al. illustrating the nonobviousness of the invention described within this disclosure. The authors of the patent from the prior art state that “The present method is based on the fact that any event in a baseball game is susceptible to being isolated and quantifiably measured in terms of whether the outcome significantly increases or decreases a team's chances of winning the game.” They continue stating that “This [the present method] is distinctly unique to baseball, as compared with basketball, football or ice hockey for which the dynamic interactive flow of the game prevents the individual plays in a game from being conveniently broken down into discrete isolated events.” Contrary to these statements, this invention can be used in football, basketball, and even baseball as well as many other sports.

4.2 The Game from a Scientific Perspective

There are numerous scientific fields under investigation to gain more insight into many naturally occurring phenomena. Scientific studies deal primarily with naturally occurring phenomena or some manipulation thereof in the form of human created technology. Sports¹, however, doesn't quite fall into either one of these categories even though all of the actions are subjected to the conditions and the environment in which the game is being played. Although all of the physical phenomena of the game ultimately revert back to natural laws of physics and related fields, it is not these in which we try to gain a better understanding. It is the ability of the athlete(s) to perform their best either within the environmental conditions in which the game is being played or against some opponent who may alter their ability to play the game at their best. Because of the unchoatic nature of the games there is a dynamic that takes place which is governed by the design of the game, for instance, its rules, penalties, the field of play, and probably most important, the athlete's strategic approach to achieve something in the least amount of time or to acquire more or less points than the competition.
¹The science of training is excluded from this statement as it pertains to physiology, psychology, diet, exercise, etc. as they can be considered to be applied sciences.

In a pursuit to understand the games of basketball and football from a scientific point of view one must convert the notion of information, in this case of sports statistics and phenomena, into a scientific concept by quantifying the observed phenomena, thus making it measurable, and as a result analyzable. This perspective, if viewed properly, then allows one to evaluate a player, team, conference, or any grouping of individuals or subset of players into an analyzable entity. This approach can be applied to any number of games, consecutive in nature, randomly chosen, or a particular subset of games predetermined by some restriction taken from the statistics available. These analyzable entities may be evaluated in numerous ways and compared to other analyzable entities to measure with some certainty their efficiency and performance levels accordingly.

The whole purpose of incorporating the scientific method is to make the approach more systematic and as a result more reliable. One can argue that the traditional approach is not developed from any hypothetical principles and devised only as a means to keep track of a player's contributions. Essentially, it only allows us to compare the contributions of one player to the contributions of another player. Naturally, we credit the player with the best statistical performance in terms of points, rebounds, assists, etc. as the best overall player on a team. Many times players with minimal statistical performances are just as important for providing key contributions throughout the game, yet overlooked because there is an tendency to judge according to quantity instead of quality. By diverting our attention away from a general quantitative analysis of statistics towards a more dynamical analysis this new scientific approach should amend any misunderstandings we have about the game.

4.3 Current Practice for Recording Statistics

Upon talking to several statisticians working for different NBA teams, the various practices of obtaining game statistics for those teams revealed suggest that the current invention can aide statisticians in efficient statistical calculations especially in the long-term realm. This can be important when searching for those statistical “gems” of information that can be obtained only after a substantial amount of statistical data has been acquired.

Those current practices include entering data or essentially tabulating statistics for both teams and their respective players using a touch-screen laptop. For example, if a player scores from a free-throw attempt, field goal attempt, or three-point attempt, the respective amount of points is tabulated for that particular player and team. This suggests that the information is tabulated for only a limited number of game situations and previous information about the game is lost after the statistic has been tabulated, counter incremented, or situation modified.

Another statistician provided a final stats package that is compiled after each and every game. The usual box score information is provided in this package for all of the players and teams and also a chronological account recording the game in a phenomenological manner associating a time in the game which is very similar to the current invention but lacks the binary or logical representation as a quantized event for each recorded event. It instead records the information as text in a field with no logical interpretation. This is done by several statisticians (approximately 3) one of which types the chronological statistical account into the computer while the others verbally communicate the game information to him. On the other hand this quantized event representation allows computerized algorithms to resolve the game events efficiently and also calculate statistical quantities along with a plethora of statistical reduction parameters disposable to the statistician. The current invention would allow the events to be input using buttons designated for each and every possible event and no typing would be necessary similar to a point-of-sale application at a restaurant. Subsequently an extensive analysis can then be performed on the data and other data that has been retrieved from a computer database.

### 5 BRIEF SUMMARY OF THE INVENTION

At the present time our knowledge of sports such as basketball and football is inadequate and insufficient to provide a genuinely insightful analysis. The present invention aims to extend our knowledge by creating a scientific environment in which to study sports. Until now a plausible method for scientifically analyzing sports has eluded our grasp. Here we disclose an ingenious way of decomposing the games of basketball and football into their most elegant analytical form—as discretized or quantized events.

By virtue of this decomposition event data structures have been rigorously constructed for the efficient and exhaustive analysis of sports statistics and phenomena. We also introduce analytical principles, concepts, and methods including visual aides like graphs and charts which will help coaches evaluate their team and their players performance and also help scouts in making evaluations on prospective players. Lastly we provide a simulation which allows us to artificially recreate a game using computerized Monte Carlo Techniques for the randomized generation of events in a completely fictitious environment. This project will drastically revolutionize the way in which sports statistics and phenomena are collected, processed, analyzed, manipulated, and comprehended by enhancing the information technology associated with these sports.

### 6 BRIEF DESCRIPTION OF THE SEVERAL VIEWS OF THE DRAWING

FIG. 1 Here is an example of seasonal statistics as it is presented in the traditional approach.

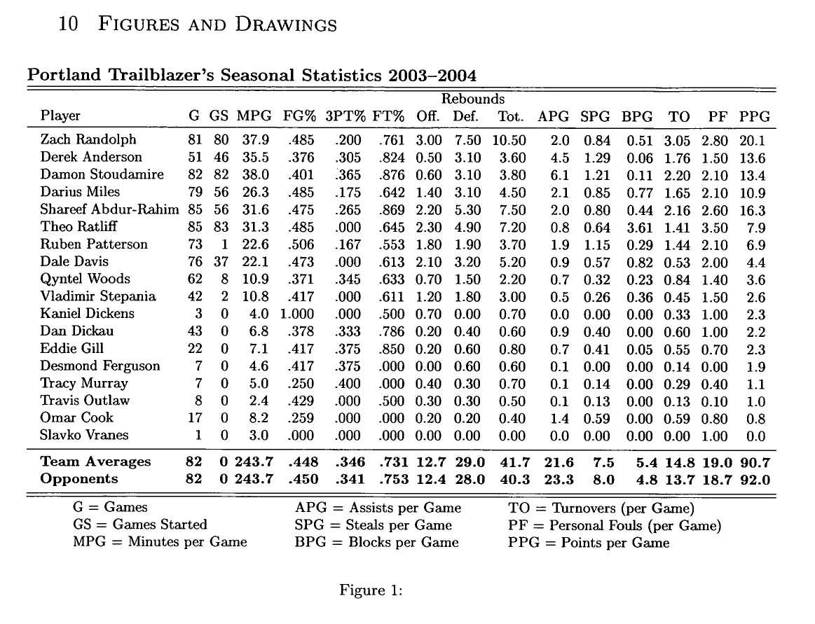

FIG. 2 This is an example of an extended box score which presents statistics for only one game as they are tabulated in the traditional approach.

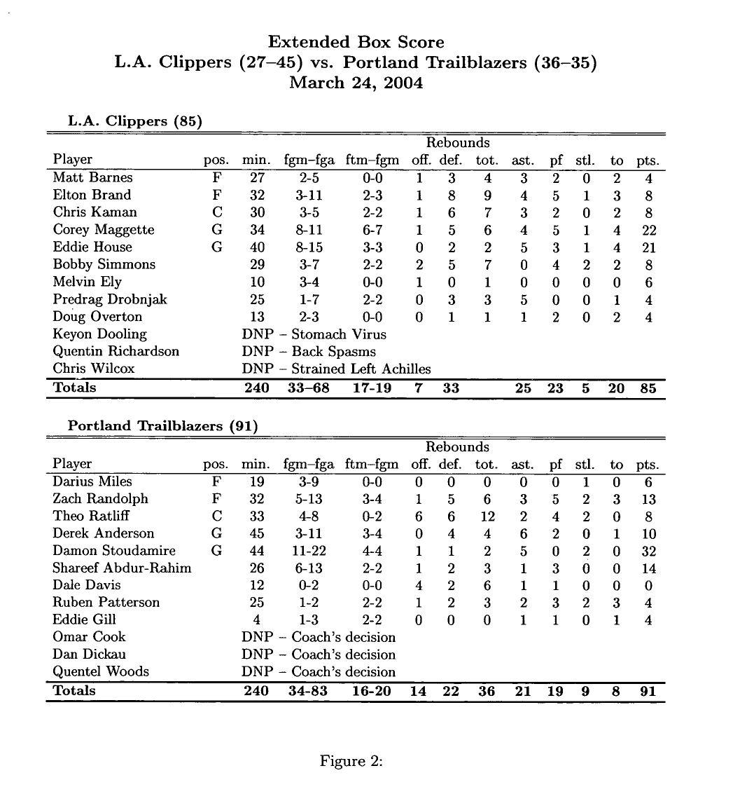

FIG. 3 This is the general design/layout schematic of the quantized event data structure. The information it represents may be broken down into two main categories: Characteristic and Temporal (Sequential). Additional sub-characteristics are also shown for each category.

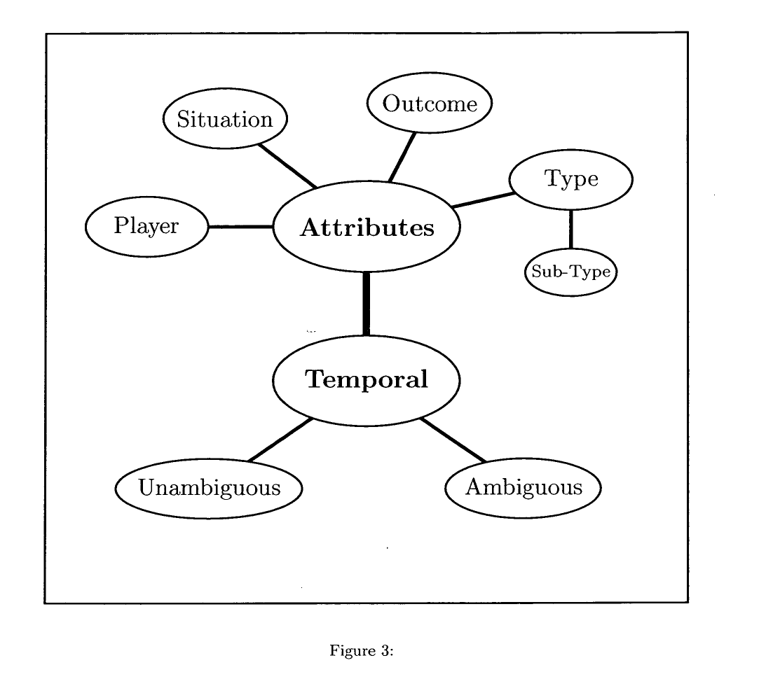

FIG. 4 This is the link list format of the chronological sequence of events. The uppermost box is the event list master structure. The boxes are the quantized events. These are appended onto the end of the list in the order of occurrence. The link list implementation also allows us to insert or remove events if there was a mistake or modification made.

FIG. 5 The event sieve process is shown on a data sample of events. The uppermost box is the event sieve structure and the smaller boxes are the actual events. After the event sieve has sifted through all of the events we see the accepted events are highlighted and the rejected events crossed out.

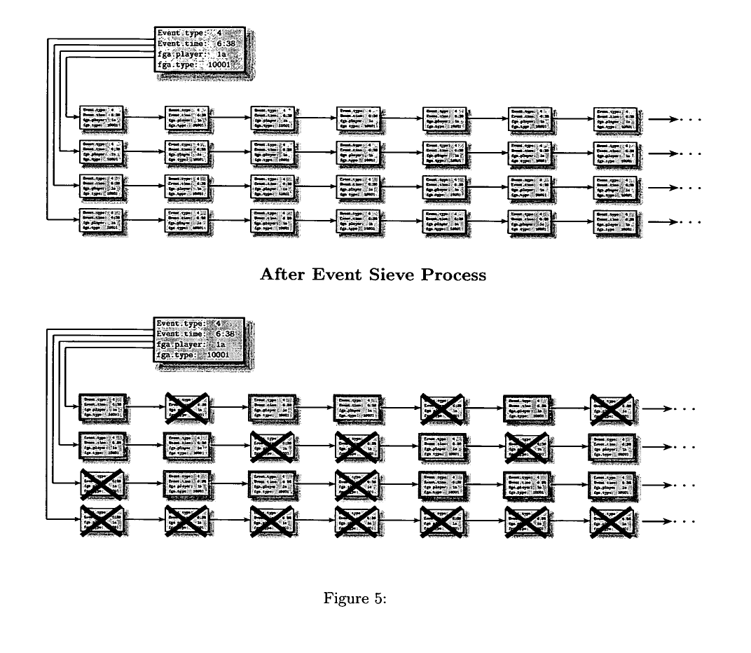

FIG. 6 The data structure hierarchy is seen here broken down into three tiers of nodes. The highest-tier consists of seasonal structures, the middle tier consists of game structures, and the lowest tier of event elements.

FIG. 7 This is a plot of all of the positions for all of the NBA teams for the 2003-2004 regular season. The Minnesota Timberwolves are labeled showing the only team that had both positive offensive and defensive positions.

FIG. 8 This graphs shows a breakdown of the positions for each quarter (OT omitted) of a game for each team for the entire season.

FIG. 9 This is the plots of the performances (offensive, defensive, total) for the Portland Trail-blazer for the entire NBA season (all 82 games) using the prescription for calculating performance in this section.

FIG. 10 These are examples of player tracking charts for the continuous case. We can see exactly when a player was involved in the game and which groups of players were active together. The red vertical lines show when timeouts were called. The hatched filled regions show periods when a particular group of players were active in the game or any other specific underlying properties of the game.

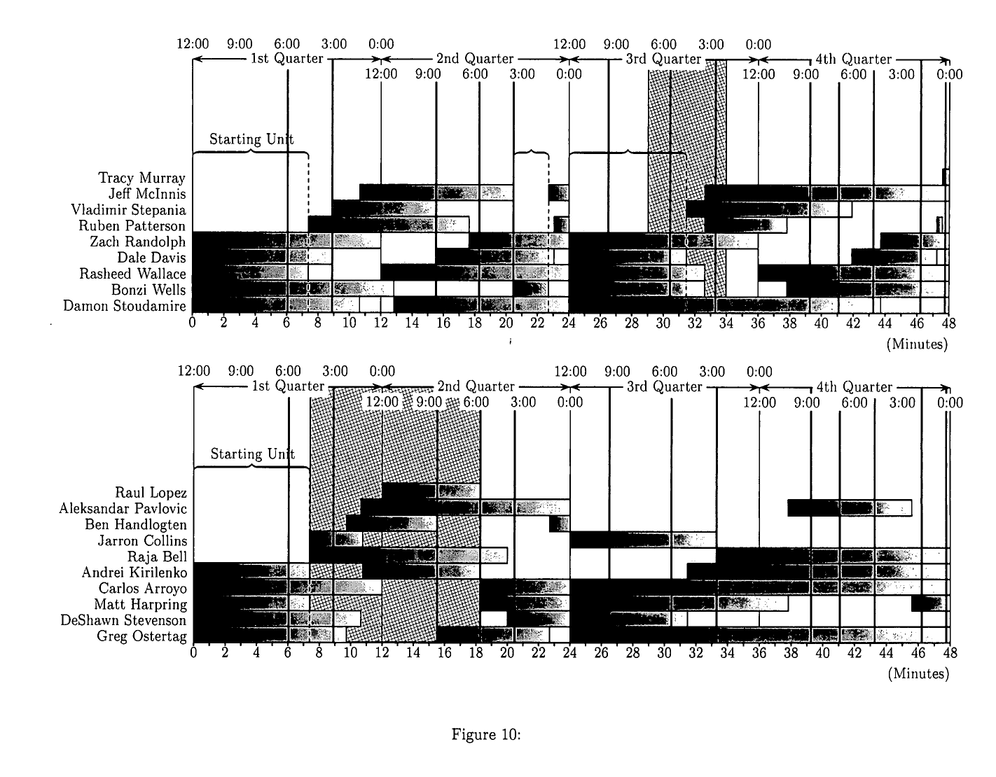

FIG. 11 The Gaussian weighting function along with the data points f(xₙ) are shown illustrating how the new data points g(yₘ) are formed from this special averaging technique.

FIG. 12 Using the square step method for averaging the data points f(xₙ) the parameter n representing the length in minutes of an interval is shown for n=1, 2, 4, 8.

FIG. 13 Using the Gaussian method for averaging the data points f(xₙ) we vary the parameter σ² from 1.0 to 3.0 to show smooth ascensions and decensions in the data. As we increase σ² we notice that there is less fluctuation in the generated curve.

FIG. 14 This schematic outlines step-by-step the complete process for the generation of events using computerized Monte Carlo techniques.

### 7 DETAILED DESCRIPTION OF THE INVENTION

7.1 Description of the Event Analysis Software Implementation

The Event Analysis Software Implementation (EASI) is designed specifically for the collection, retrieval, and manipulation of sports² statistics in the form of discretized events which allows the data to be scientifically analyzed for the extraction of meaningful results and interpretations. This system will enable us to determine any dynamical relationships that may exist between the statistical quantities which was not the case for the traditional approach. This is achieved because within the continuous action of the game all occurrences of statistical phenomena can be distinguished into discrete, isolated, easily identifiable events.
²These sports include basketball, football, baseball, etc.

After thoroughly reading this section it will be clear how the EASI approach preserves and transforms the games of basketball, football, and other sports into their most elegant analytical form for a scientific treatment of the game. We will go from a system of observable phenomena seemingly void of any apparent order to a completely logical, organized arrangement of analyzable entities otherwise known as quantized events. We are now in a position to make intelligent guesses about the phenomenological dynamics the game exhibits and then test the validity of our conjectures. With the EASI approach the game of basketball is reduced into its pristine scientific analytical form allowing for the continued, progressive analysis of sports statistics and phenomena.

7.1.1 Definition of a Quantized Event

First, we shall establish the concept of a quantized event. Each individual occurrence of some distinguishable observable action or phenomena³ which alters the status of the game in a discrete manner is considered to be a quantifiable event. Each individual occurrence of a statistical phenomenon, stoppage of game play (timeout), or substitution of players are all regarded as quantifiable events. Every event that takes place will in some way alter the amount of some particular statistical quantity, increment a counter of some type, or modify a well-defined situation during which the event happened. All of the attributes associated with the event are recorded including the sub-type of the event, the time it happened (relative to the game clock [unambiguous time] and shot clock [ambiguous time]), and the player(s) or team(s) involved.
³This includes actions or phenomena which may also potentially or indirectly alter the status of the game. For example, this includes passes or the number of touches a player has during a possession which aren't normally recorded as statistics.

The quantized event serves as the most basic unit of information describing any phenomenon in its entirety. As such it stands alone completely from any other quantized event. The information associated with the quantized event may be classified into two basic categories: characteristic data and temporal data. In the situation that the characteristic data is identical for any two quantized events the unambiguous temporal data will always distinguish the two events. The unambiguous time of the game is recorded as a time from a clock, usually the game clock, that has started to elapse since the beginning of the contest. The unambiguous time can be a clock other than the game clock. For example, it could be a clock which has begun elapsing since the beginning of the game and is does not stop until the game is completely over with which is slightly different from the ordinary game clock which only elapses while the game is in progress. Or it could be a clock which only elapses while only a particular player is in the game. In baseball where there is no game clock, a clock can still be appointed to give each event a sense of time.

The ambiguous time cannot discern between events with identical characteristic data. The ambiguous time is recorded as a time from a clock, usually a play clock (in football) or a shot clock (in basketball), that is continually reset throughout the sport contest. The ambiguous time is not limited to these normally implemented resetable clocks and can be instated as arbitrary clocks that are reset as a player is substituted out and back in the game or based on some other definite event. In baseball, it could be a clock that is reset between any inning, half-inning, or even between pitches.

Let's now describe the characteristic data in more detail. The characteristic data specifies the type of event and any other pertinent or relevant information accurately describing the event in distinguishable detail. We can further specify the sub-type of event (if there is one), player data indicating a player or a team involved in or responsible for the event, situational data describing a well-defined situation during which the event took place, and finally outcome data describing the result of the event. Let's expound more on these concepts.

Many events in a basketball can be further classified such as a field goal attempt. There are lay-ups, slam dunks, jumpers, etc. which are all a special kind of field goal attempt. We also specify which player(s), coach, team, and referees were involved in the event in the player data. In football, this could be the down and the yards needed to get a first down or a touchdown. In basketball, a 3-on-1 fast-break could also be a situation in which a basket was made or during which a steal occurred. The outcome data is a piece of information specifying the result of an event. For example a field goal attempt and a free throw attempt can either be made or missed. A possession in football can either be lost or retained as a result of a fumble. A result for a pass attempt can be one of three things: a reception, an interception, or an incompletion. For a running play (excluding turnovers) the outcome may be might be the total yards gained or lost on the play, whether a first down or a touch down was attained on the play.

In baseball each play consists of three intimately related quantized events: the pitch event, the batting event, the fielding event. These events can be grouped together as quantized events into what is known as a “quantized play” since they happen so often in this sequence. The pitch event is a regular pitch including intentional walk pitches not including pick-off attempts. The reason we don't include pick-off attempts is because there is no batting event. It has its very own “quantized play” in which usual outcome information regarding the at-bat, or batting event is omitted. The batting event can be described by the type of swing given by the batter. The fielding event can be described by the type of fielding play that is made on the ball in play. A player substitution such as a pitcher change, pinch batter, or a pinch runner are all regarded as basic quantized events.

Another reason for introducing the “quantized play” in baseball is because of the possible number of outcomes an event could have. Various outcomes could be a called strike, strike swinging, a ball, a foul which in turn results in a strike if there are no strikes or only one strike, a strike out, a fielded out, a hit, an extra base hit such as a double, triple, or inside the park home run, a home run. Because there is alot information to track and the information pertains to both the pitching event as well as the batting event it is beneficial for us to merge these events therefore eliminating any redundant outcome information. For example, a called strike is just as dependent on the batter not giving a swing as it is the type of pitch issued by the pitcher. In the “quantized play” format we would only need to provide this information only once. Even the fielding event has a strong relationship to the pitching event as well. So even though we implement a “quantized play” most of the time in baseball, it is still fundamentally formulated from quantized events.

Other outcomes include a stolen base and which base was stolen. These can only happen when there is a baserunner on base. Therefore we can consider this as a special “quantized play” where there are now four intimately related quantized events consisting of the original three quantized event plus a fourth quantized baserunning event. We could have implemented the fourth baserunning quantized event in the original “quantized play”, but again we strive to eliminate as much extraneous information as possible.

Situational data in baseball is a well-defined situation during which a quantized event takes place such as the number of players on base, which bases are occupied, and the number of balls, strikes, and outs there are. Reiterating the above we prefer to provide this information only once, and since the situational data is going to be same for each and every “quantized play” which is composed of these quantized events we're better off merging them as such.

Because of the rigorous form of the quantized events and “quantized plays” we can easily design data structures representing the phenomenological information portrayed by these events. These data structures gives each and every quantized event and “quantized play” a special form of binary representation such that algorithms or code segments can be applied to them discerning the type of event that happened along with the time of the event and all of the underlying characteristics for that event. We can then sift through countless numbers of quantized events obtained from multiple sport contests very efficiently and perform an statistical analysis on them in order to obtain some desired result. In the next section we show how the quantized events are implemented as a data structure.

7.1.2 The Quantized Event Data Structure and its Functionality

The event data structure can be claimed to be the most vital part of EASI since the capacity of the analysis is encompassed within the flexibility and versatility of its design. It plays an important role with the way the data is acquired by means of some user interface and subsequently stored onto computer readable media in a searchable database. It also influences the way in which the data is retrieved and placed into memory for further processing and manipulation which is described in Section 7.1.4. It gives the quantized events a special form of binary representation so that logical decisions can be made on them using a set of specialized algorithms which exploits the functionality of the structure.

Now we describe the event data structure in its entirety. The very first member of the event data structure stores the event type. It helps us identify what kind of information is actually stored in the structure since many different types of events may occupy the same space. Next, the second member is the event time and it stores the time the event occurred in minutes and seconds relative to both the game clock (unambiguous), the shot clock (ambiguous), or any additional clock (unambiguous/ambiguous) that has been implemented. Finally, the third member stores all of the various events and their respective properties and underlying characteristics are commented within the structure for better clarity. The event team or the event player(s) that is responsible for the event is also recorded.

All game information and statistical phenomena cannot be stored explicitly within the event structure due to the properties and characteristics that certain game phenomena possess. One thing that must be emphasized is that the event data structure does not hold values for any of the statistical quantities. The point to be made is that the event data structure is strictly a phenomenological entity. All statistical values are then tabulated by algorithms which recognize and interpret the game phenomena by incrementing the appropriate statistical value within a separate data structure. These data structures are responsible for holding current game status and real-time data like which players are in the game, timeouts remaining for each team, and the (current) total statistics for the teams and players and various other statistical breakdowns.

Every statistical quantity has its own phenomenological conjugates from which we determine how to modify the current game statistics and current game status values. Field goal attempts and free throw attempts are the phenomenological conjugates for the points statistical quantity. Immediately we notice that more than one phenomenological conjugate may be associated with each statistical quantity. This is how these particular phenomenological conjugates are interpreted by the algorithms: No points are issued to either team for a missed field goal or free throw attempt; only one (1) point is tallied to the team and player converting a free throw attempt; two (2) points are tallied to a team and player converting a field goal attempt which is not a three point attempt in which case three (3) points would be granted. Points are also awarded if there was a goal tending or taken away if there was a basket interference.

A turnover is a discrete statistic that has been intentionally left out of the event data structure. It must be deduced from all possible phenomenological conjugates that are found within the event data structure itself. It is a statistic which results phenomenologically from either a violation, steal, out-of-bounds, or an offensive foul which are included. When any one of these events take place a turnover will be issued to the appropriate player and team turning the ball over.

We can now turn to the notion of a compound event. These events aren't standalone events but always happen together, or in juxtaposition with another parent event. Assists and blocks are examples of events which must happen adjacent to a field goal attempt. So if there was an assist or a block, then there must have also been a field goal attempt taken. The converse of the previous statement is not necessarily true so we put the assist and block event structures inside the field goal attempt structure. The same is also true of free throw attempts which can only happen as the result of a foul or some other infraction. The reason for the compound event is that it saves time in the analysis phase by combining events that are known to be intimately related to one another.

One may have also noticed that possessions are not included in the event data structure. Possessions are not events happening at some definite time thereby making the event time variable void. Instead they may be deduced from the event structure in the same way as any other statistical quantity. Possessions are usually relinquished by a team after a missed field goal attempt and rebound by their opponents, but a possession can be retained with an offensive rebound. Offensive fouls, violations, and steals also result in a change of possession. Therefore, in principle, once the first possession from the initial jumpball has been established all ensuing possessions can be determined so long as we know the implications of all the designated events leading to a change of possession.

The miscellaneous structure is an all-purpose structure designed to make the entire event structure flexible and versatile. Any events that have been overlooked and unanticipated for which there are no prescribed effects or events which happen very infrequently should be placed into this structure. Injuries and ejections are examples of events that might be included in this structure or in some other special structure. At this stage the miscellaneous structure only represents an out-of-bounds event which doesn't quite fit well into any of the other event types.

Some additional features that can also be included within this structure or a separate structure are passes and touches. The number of passes a team makes and the number of touches a player gets during each possession can be recorded and analyzed although this might put extra load on the data acquisition. Tipped balls after missed field goal attempts are normally counted as offensive rebounds, but because of the versatility of the event data structure we can analyze this type of event without crediting the player with an offensive rebound by setting some simple configuration options. In this scenario the only time a player would be credited with an offensive rebound is if they come down with the ball for a possible decision to pass the ball out. Even if the player decides to immediately put back a shot within a close proximity of the basket, it would still be considered a new possession in addition to an offensive rebound. Yet another feature is to neglect improbable long-distance field goal attempts which usually take place at the end of quarters and halves. Anytime a desperation attempt is taken we can record that as and ignore these from the analysis. Since these shots are usually missed and some players are very conscientious of their statistics we may omit these types of events whether the shot is made or missed. These are just a few of the finicky features that the versatility of the event data structure allows us to take into consideration.

Lastly we may also incorporate spatial attributes into the quantized event data structure using an invention by Carlbom, et al. which tracks the spatial-temporal trajectory of various athletes and objects during a sporting contest. Some of these attributes may be the position of players and the motion of the ball relative to the court or playing field or relative to one another.

7.1.3 The Quantized Event Sieve Procedure

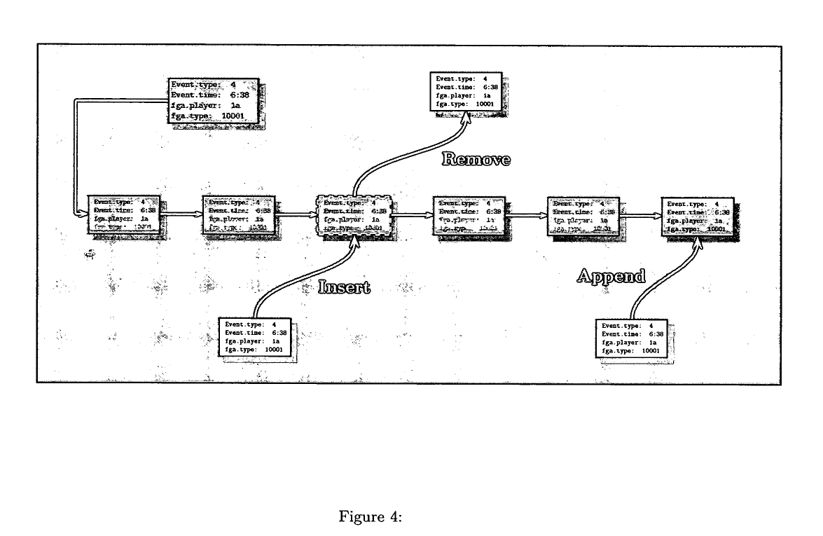

Now that we have a system in place for collecting all of the game phenomena in the form of quantized events, we are ready to take full advantage of the event screening techniques using the event sieve mechanism. Given a data sample of events representing a game each event can either be accepted or rejected on the basis of some prescribed set of screening conditions. The event data structures are placed into memory in what are known as linked lists. This facilitates the easy insertion and removal of events through dynamic memory allocation as opposed to putting them into an array which is fixed memory. We can see a diagram of this in FIG. 4. Since we do not know beforehand how many events will take place in a game, it makes more sense to append events onto the end of a list without having to worry about running out of space or how much memory to allocate to an array.

Let's first understand what the event sieve is and the process by which the event sieve works. The event sieve is a data structure which holds a pointer variable to an event in question and also progressive data such as cumulative statistics and team statistics for only the accepted events. It is used in conjunction with algorithms which advance the pointer to the next event in the list thus traversing a chronological list sequence of events. As it traverses the list it is responsible for performing several different tasks. These tasks include keeping track of which players are in the game, verifying whether or not the event satisfies the prescribed set and/or default set of screening criteria, and finally computing statistics for only the accepted events. It is also responsible for tabulating other statistically derived quantities which are not readily available to us within the event data structure and accept/reject events based off of these quantities in the exact same way.

Therefore an event may be rejected from consideration from a combination of two different methods. The first method is by validating specific information that the event data structure holds. For example if the event type, or event sub-type, is a specific type (for example a 3-PT FGA) which we don't want to include in the analysis, we may easily remove or disregard this event. Events can be disregarded based on statistical information handled by the event sieve itself which contains the current (total) statistics, any derivable statistics, or any information that isn't handled by the event data structure such as possessions and current active players. In the case of statistical derivatives, it might be necessary to traverse the list twice, the first traversal calculating any statistical derivatives, and the second traversal bypassing any events which do not qualify.

There is a subtle distinction that needs to be made for the rejection of events based on player involvement. The first way is based on a player who is responsible for the actual event. In some instances there can be two players involved in the same event, but usually, if not always, those players will be on opposite teams. The only event that can have more than one player from the same team is an assisted field goal attempt, but the event data structure knows which player is responsible for the converted field goal and which is responsible for the assist. The second way is based on the players who are active in the game which is somewhat different than the first scenario. In this scenario we are considering all events that occur while a particular set of players are in the game whether or not those actual players were responsible or directly involved in the event. In this case the event sieve would reference itself for the currently active players and consider only those events for which the selected group of players are in the game.

In the analysis section it will be shown that the event sieve procedure will allow us to compile the statistics in a myriad of ways exhausting all conceivable combinations of elements based on predefined screening parameters. For all intensive purposes the traditional approach only has the capacity to allow one to tabulate statistics for general situations. Even attempting to calculate the simplest dynamical quantities (which we will explore later) would prove to be formidable since one would have to review countless game footage and then manually tabulate these quantities which is unreasonable. In addition, many statistical quantities of interest can only be conceived in retrospect, that is once the entire game, and in certain instances, the entire season has been played out.

Therefore as a prerequisite the entire game must be preserved in its original phenomenological format instead of tabulating statistics beforehand with no prior knowledge of how the game may evolve as is the case with the traditional approach. This is without a doubt another very important feature EASI has to offer towards the analysis efforts. Statisticians and analysts are at liberty to analyze any realistic conceivable phenomena which the event data structure and event sieve procedure gives us access to. Plus there will no longer be a need to review countless game footage or reference statistical logbooks in order to manually calculate any statistics which is so often done with the current practice. So it should be apparent how the information technology aspect of the game is also upgraded. With the EASI approach we have reduced the game of basketball into its pristine scientific analytical form allowing for the continued, progressive analysis of sports statistics and phenomena.

7.1.4 Data Structure Hierarchy

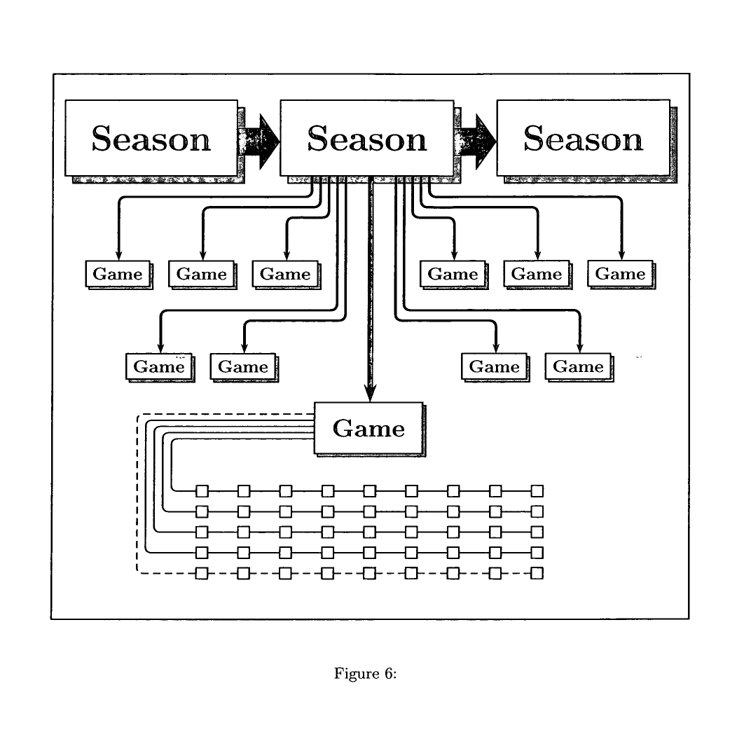

The data structure hierarchy is a well-organized, tree-like configuration of elements for the efficient analysis and manipulation of all the collected data. The hierarchy is organized into three (3) tiers that are split according to the season, the game, and the events which occur within the game (which are also subdivided into which quarter the event happened for better efficiency). So in addition to the event data structures that we are already familiar with, we must construct game data structures which are the parent data structures for the event data structures, and we must also construct seasonal data structures which are the parent data structures for the game data structures. These various structures serve as nodes within the hierarchy. The data structure hierarchy is shown in FIG. 6.

In the highest tier we have the seasonal data structures also referred to as nodes. They contain all pertinent information about the particular season that each one represents and they also point to all games that were played in that season. Such information includes the conference and division each team belongs to (for that season as divisions and conferences change) and team seasonal statistics (totals and averages). It also includes the players that belong to each team as well as a complete listing or roster of players who are sanctioned by the league. Any statistical and scientifically analyzed or derivative data that can be used to reject games may be kept within this structure or pointed to by this structure in order to keep its size from becoming overwhelmingly large.

In the middle tier we have the game data structures which are analogous to the seasonal data structure except now they contain all pertinent information for the particular game that each one represents. Such information includes the teams who played, the date the game was played, the final score and the points scored by each team in each quarter, the statistics (total and average) for both the teams and players as well as any computationally derived information that may be useful in the exclusion of events. In an effort to optimize the analysis the game data structure holds four (4) (or more if the game went into overtime) variables which points to the beginning of a list of events. This is in contrast to storing all of the events from one game into one long chain even though it may still be done this way if absolutely necessary.

And finally, in the bottom tier we have the event data structures which has already been explained in detail in the previous section. This prompts us now to explore methods for storing these structures within a database. We could simply keep all of these element types (season/game/event) segregated in which case all of these different elements would need to be stored in separate files for the consistent reading and writing of data to a file. On the other hand we could integrate each data structure type into one large data structure by forming the union between the structure types similar to what was done within the event data structure. Then we could introduce the storage of all the data structure types into one file, but this would promote extremely large file sizes.

In both cases additional identification information would need to be stored in each of the structure types before it is written to a file to be able to distinguish it from other elements within the same class. For example events could be uniquely identified and properly placed into the data structure hierarchy by tagging additional identification information for both teams that played as well as the date of the game. If we choose to split the events in a quarterly format like was mentioned earlier, then we would need to tag the event structures with the quarter in which the event took place before saving the data to a file. Upon retrieving the data from storage we can now successfully recreate the data structure hierarchy back into addressable memory.

7.1.5 Data Acquisition and Remote Database Access

Data acquisition is a fairly simple and straightforward procedure by means of a standard user interface. Upon the occurrence of some game phenomena the minimal amount of essential data would need to be entered by a user who is monitoring the game. This can be done through a keyboard input device or a touch-screen laptop device which is the current method of recording statistics in the NBA. A signal carrying the game clock time and 24-second shot clock time data should be sent to the same input device so that the user doesn't need to record the time manually for each and every event that takes place. So if a group of users were skilled enough to enter the events simultaneously as they happened

In order to facilitate the process of acquiring data only the currently active players will have fields which are prominently displayed for input. So this will reduce the number of players available for input from the number of eligible players for each team down to only five (5). The event types should also be displayed with an order of priority taken into consideration. So common events like field goal attempts should be prominently displayed whereas events like jumpballs shouldn't be made as obvious. As the events are recorded one-by-one, each event is appended to the tail of the existing list of elements for that quarter. Because these events are put into a linked list, if the user mistypes an event or an unexpected situation arises where an event must be removed or changed, it will be a simple matter to remove and insert the proper event, if necessary.

The game sometimes moves at an unusually fast pace where events happen one right after the other before the user would have time to recognize all of the events and input them all in sync with the game clock. So it would be necessary to have at least two or more individuals to keep up with the pace of the game. With the addition of a digital video recorder (DVR) along with a playback monitor events that happen at a fast rate can be slowed down, paused, and reviewed to attain the highest level of accuracy for the proper determination of events before they are recorded. Sometimes it is hard to determine who tipped in a shot (during a series of tipped ball field goal attempts), or who should receive credit for a steal. So the DVR system would also keep the time information stored so it would be easy to figure out when the events happened relative to both clocks.

This system is intended to collect data from multiple sporting contests and integrate all of the data in the form of quantized events for an extensive integrated on-line analysis. Because multiple sporting contests often happen concurrently at several different locations throughout the country it is necessary to have access to a remote databases across some communications network in order to perform this kind of analysis. Therefore real-time analysis can take place between more than one sport contest and personnel at each sport contest would have complete access to the data as it is acquired.

7.2 Formulation of Analytical Concepts from Scientific Principles

In this section we propose a few concepts that will facilitate the analysis. We start off with offensive and defensive positions which are key in the relative positioning of teams in terms of their points production. Then we derive performance gauge quantities which are extensions of the offensive and defensive positions. Finally we talk about team efficiency and player productivity which will tie together all of these phenomenological concepts into a complete, cohesive package.

7.2.1 Offensive and Defensive Positions

Not surprisingly, the two most important aspects of the game are the offense and defense. Generally speaking, a team's offense can be considered to be all actions while a team has possession of the ball which go toward scoring additional points. Defense, on the other hand, is all efforts which go toward denying the opposing team scoring opportunities while a team does not have possession. These definitions do not provide the quantitative relationships necessary to make comparisons or to gauge according to some scale precisely how well a team's offense or defense is performing. Therefore, we need to develop a formal approach in which rules are defined via mathematical expressions which can be numerically analyzed and tested for reliability and also modified for correctness.

We begin by trying to find measures (or estimates) for a team's offense and defense which we shall hereafter refer to as a team's offensive and defensive positions. Because offense can be assumed to be directly proportional to the amount of points scored by a team in a game, we are persuaded into finding the league points-per-game average since it tells us how many points are scored in a typical basketball game. The points-per-game average is best perceived as an expectation value, not necessarily because we expect every team to score within close proximity of the league average, but instead to determine the amount of deviation between this value and the score posted by a team in a game.

Say, for example, that the league points-per-game average is 92.5 points and for a particular game the home team scores 98 points and the visiting team scores 86 points. By taking the difference between the amount of points scored by a team with the league points-per-game average we have a measure for offense and thus defense. So the offensive position for the home and guest teams are +5.5 and −6.5 points, respectively. The defensive position is simply the offensive position negated and attributed to the opposite team. Therefore, the defensive position for the home and guest teams are +6.5 and −5.5 points, respectively. Comparatively speaking, a greater positive value indicates a stronger offensive/defensive position, whereas a greater negative value indicates a weaker position.

| | | | | |
|---|---|---|---|---|
| Offensive Position | ≡ | Individual Team | − | Adjusted League |
| | | Scoring Average | | Scoring Average |
| Defensive Position | ≡ | Adjusted League | − | Individual Team |
| | | Scoring Average | | Opposition |
| | | | | Scoring Average |
| Corrected | ≡ | Corrected | − | Corrected Adjusted |
| Offensive Position | | Individual Team | | League |
| | | Scoring Average | | Scoring Average |
| Corrected | ≡ | Corrected Adjusted | − | Corrected |
| Defensive Position | | League | | Individual Team |
| | | Scoring Average | | Opposition |
| | | | | Scoring Average |

In the previous example, the positions calculated dealt specifically for one game only. The positions will fluctuate from game to game as the schedule of opponents vary and other factors change. More consistent results can be obtained by substituting individual team scoring averages in place of the original game scores that were used before. Using individual team scoring averages reflects a team's average offensive position and can be compared amongst the other team's offensive positions. The same also applies for the defensive position if we substitute an individual team's opponent's or defensive scoring average to take the place of the opponent's score. There still are a couple of adjustments that need to be applied to the league points-per-game average before it can be claimed that we have arrived at the most accurate results.

For each team there is an adjusted league scoring average which is slightly different (usually less than one or two points) from the ordinary league scoring average. The adjusted league averages are obtained by removing each team from the league as though they didn't exist and calculating the league average for the remaining teams. So the adjusted offensive position for a specific team is that team's adjusted league scoring average less their offensive scoring average. The adjusted defensive position is the same as the adjusted offensive position except now the team's scoring average is replaced with it's defensive scoring average. This prohibits us from comparing any teams with themselves. The idea is very easily understood if we envision the NBA as an isolated system, or universe, being composed of the entire league of NBA teams. The positional parameters are really just comparisons between some team and the rest of the league so we must be careful not to include any of their points or their opponents points in the adjusted league average.

Suppose that an offensive juggernaut existed amongst the teams and they scored a ridiculous amount of points, say 10,001 points, per game. Their average alone would inflate the league average to a value so enormous that their offensive position would appear to be much lesser than it really is although it would still be relatively high. Along the same lines their defensive position would appear greater than it should be. These arguments provide some justification for adjusting the league average for each team.

Lastly we correct for the fact that some games go into overtime while others do not. Any points scored outside of regulation during overtime periods are dismissed from the standard analysis which we will speak more about in the analysis section. A more advanced analysis however would take these periods into account.

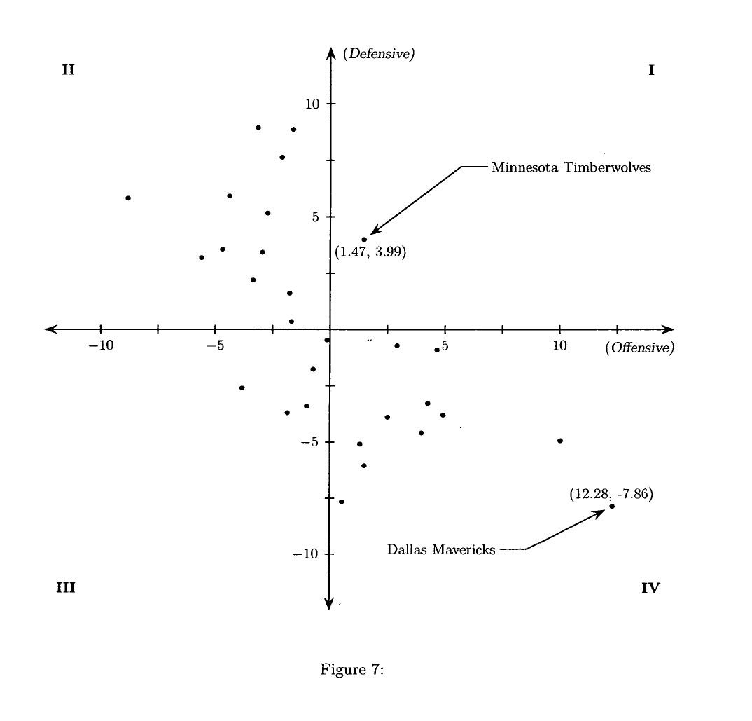

Now we can visualize the data by plotting the positions onto a 2-dimensional graph as shown in FIG. 7. The horizontal axis represents the offensive position and the vertical axis represents the defensive position. The graph can be separated into four (4) different regions also known as quadrants. The first quadrant is located in the upper, right-hand portion of the graph and teams which reside in this region have positive offensive and defensive positions. Diagonally across from this region is the third quadrant and teams in this region have negative positions. Teams with a negative (positive) offensive position and positive (negative) defensive position reside in either the first or fourth quadrant.

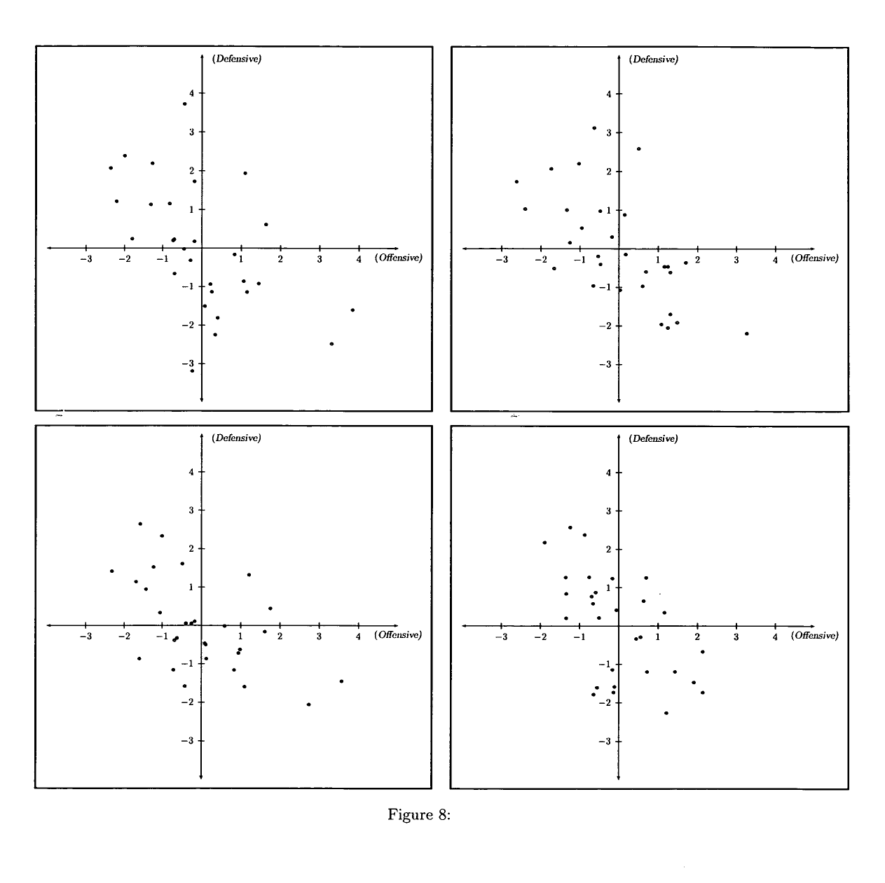

We can use the same procedure to generate positions for quarters and halves of games. Examples of these are shown in FIG. 8. A more advanced example would calculate positions for arbitrary intervals of time. For instance we can calculate the positions for only when the starters from both teams are in the game. Because the amount of time the starters are in the game is indefinite and may differ for each team we would need to calculate the average points per minute in this situation.

7.2.2 Team Performance and Efficiency

As the season progresses every team experiences inconsistencies in their ability to perform at an optimal level. As a result, teams that we expect to win (lose) against certain other teams will occasionally lose (win) to those teams. There are a plethora of reasons why a team's playing quality might be adversely affected including team chemistry, officiating, roster changes, fatigue, injuries, fortune, and even random effects in competitiveness just to name a few. Unfortunately these reasons aren't tangible, quantitatively speaking, and therefore aren't easily measurable for scientific purposes since their effects can not be represented in a discrete way. However we can overcome this dilemma by looking at these phenomena macroscopically and combining their effects into one grand variable representing the team performance.

Because of the overwhelmingly complex nature of performance compounded by our lack of understanding of the subject, we are coerced into naively deriving team performance gauges. Suppose we have Team A & Team B which are scheduled to play each other. We form the performance gauges by taking the average of Team A's offensive scoring average with Team B's defensive scoring average and vice versa. Let's say that Team A's (B's) offensive scoring average is 100.0 (90.0) ppg and defensive scoring average is 80.0 (90.0) ppg as shown in Fig.??. The values of the team performance gauges are 95.0, 85.0 for Teams A and B respectively. So naturally the performance is split into offensive and defensive parts. Suppose that the final score of the game is 95 to 105. Then Team A has offensive performance (for that game only) of 0.0 and a defensive performance of −20.0. Team B on the other hand has an offensive performance of +20.0 and a defensive performance of 0.0. To obtain the total performance we just add the offensive and defensive performances to get −20.0 for Team A and +20.0 for Team B.

| | | |
|---|---|---|
| Average Points | Performance | Points |

| | Offense | Defense | Gauge | Scored |
|---|---|---|---|---|
| Team A | 100 | 80 | 95 | 98 |
| Team B | 90 | 90 | 85 | 92 |

Positions

| | Offensive | Defensive |
|---|---|---|
| Team A | 3.0 | −7.0 |
| Team B | 7.0 | −3.0 |

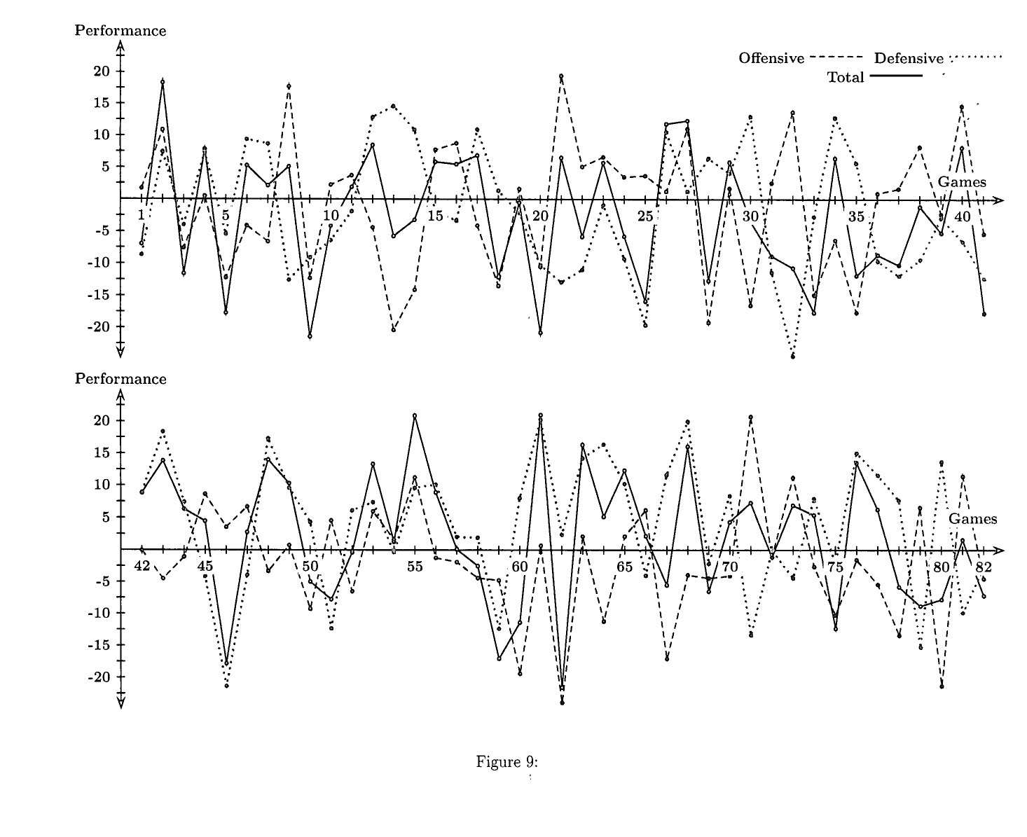

Another reason for introducing performance is that it provides us with an additional parameter in which to leverage the analysis. Just because a team scores a slew of points in a game doesn't always insinuate a great performance on their part especially if the team played against has a poor defensive position to begin with. Both wins and losses can be misleading in their own rights. So team performance puts wins, losses, and the amount of points scored in their proper perspective. We can visualize the team performance as a functions of the games played in FIG. 9. We notice that there is a high degree of volatility, but it should also be noted that this is normal behavior for this type of parameter.

Unlike performance, we need to define a quantity which doesn't take into account the level of competition but incorporates all of the statistics instead of just using the final score of a game. That quantity is team efficiency and it is the probability that a team will win a game. Team efficiency is a somewhat subjective quantity which is determined by assigning each of the individual statistics coefficients or weights based on their importance for winning a game. Only after extensive research using the EASI analysis system can we adequately define what team efficiency should be based on. What can be said about the team efficiency is that it is an absolute quantity. Therefore if a team is more efficient than its competition then they will have undoubtedly won the game whereas a team can underperform and still win the game. Ultimately efficiency is going to be the quantity we want to optimize in the simulation.

7.3 Player Productivity

Player productivity can be split up into offensive and defensive components as usual. For the offensive productivity we calculate the average points scored for a team while a player is in the game and compare (take the difference) this value to the average points scored for a team while a player is not in the game. We calculate the defensive component by calculating the same quantities as above but now for the opposing team and compare those values. This is not limited to a single player as we can calculate this quantity for any group of players that are in the game and compare to when the group is not in the game. In turns out that this is a very useful quantity to analyze and measure because it illustrates how a player's on court present effects the team as well as the opposing team both offensively and defensively.

7.4 Analysis Methods

In the upcoming sections we will investigate various analysis strategies and schemes which will aide in the extraction of meaningful results and interpretations. First, we will introduce a player tracking chart which is a unique way of visualizing which players are in the game at any given time. Next, we explain in general how functional relationships, statistical distributions, and probability densities are formed from the existing data. Finally, we show how to take advantage of EASI by outlining the most obvious techniques for statistically reducing the data. There are many different avenues of analysis that will be encountered as we learn more about the game that it is virtually impossible to present them all at these preliminary stages of the project.

7.4.1 Player Tracking Chart

We can create a player tracking chart indicating exactly which intervals of time a player was active or inactive throughout the game. We can also identify which groups of players played for each team and the interactivity between those groups with groups from the other team. In this way we can analyze how well a particular group of players from one team fared against a particular group of players from the other team. There are two schemes that can be used: discrete or continuous. The continuous scheme is much more illustrative than the discrete scheme since a bar spans across the minute columns in exact proportion to the fraction of the minute actually played by a player. We see from the figure that we can determine with ease exactly which players were in the game. We can also immediately point out when and how long the starting unit was in the game.

In the discrete case, the chart is made up of forty-eight (48) columns representing the total number of minutes in the game and a row for each player who is available to play in the game. The chart may be represented by either a discrete or continuous marking scheme. Depending on the type of chart scheme used each full minute played can be marked with either an X or with a bar that stretches across the entire width of the minute column. In the event a player only partially completed a minute that particular column would be marked with either a forward slash or a backslash depending on whether the player started or finished the minute. In the extremely improbable case that a player is active for less than one minute and neither starts nor finishes the minute a dash can be used to mark the minute.

The player tracking chart is also suitable for accommodating stoppages in play such as timeouts and dead ball situations. Dead ball situations such as between quarters, during freethrow attempts as well as timeouts are very important because player substitutions may be made at these specific times. Also changes of game strategy may be implemented in the form of offensive and defensive adjustments to change the progress of the game in favor of a particular team. Although there are no guarantees, we do expect to notice a change in the way a game evolves statistically as a result of game stoppages. Therefore it is advantageous to indicate that a stoppage of play has happened on the time tracking chart by introducing a vertical line which is placed on the chart at the exact time the stoppage occurred.

Other relevant information that should be placed on the player tracking chart are periods of unanswered points or high (low) points productivity or streaks of consecutive baskets missed or made. So as not to interfere with the information currently on the chart we can place this information in the background in the form of hatched lines or as some distinct pattern or fill design.

7.4.2 Generation of Statistical Distributions and Probability Densities

We need to be able to visualize the statistical quantities graphically with respect to time or any other statistic in order to have a clearer picture of how the game evolves. Utilizing the techniques from this section various trends and patterns will emerge providing a better insight in which to base our conjectures. Those conjectures, which are simply guesses about how the system behaves, can be tested and thoroughly analyzed by using rejection by screening criteria techniques that will be described in greater detail in the very next section. Once the statistical distributions and probability densities are determined we can use these as models for our simulation software.

Throughout the course of a game teams have a proliferation of points, and on the other hand, they have droughts, or periods when scoring points comes at a premium. It would be nice to see these trends as a functional dependence of minutes, or actually in this case, of n-minute time intervals. For a single game, there usually aren't enough points per minute to generate a smooth functional curve. A team might score three (3) points one minute, eight (8) points another minute, or possibly no points during other minutes. So the raw data is formed by summing the total points (for each team separately) for each minute and we use special averaging techniques to form smoother functional relationships.

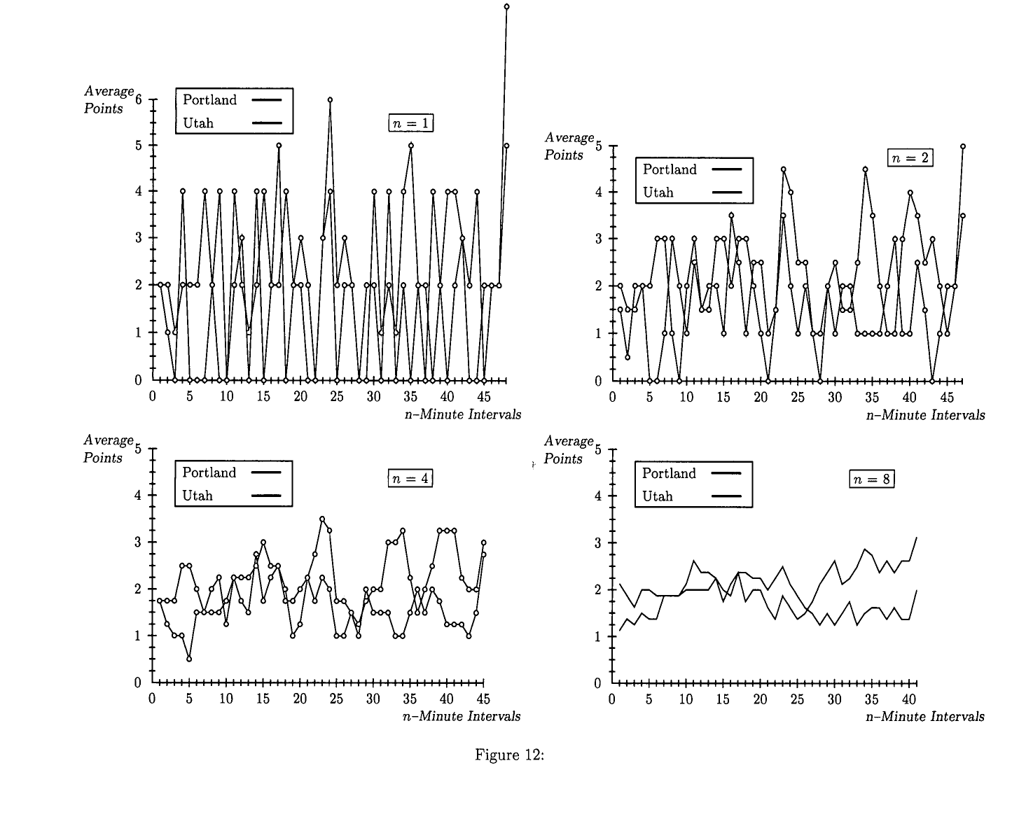

One way to work around this difficulty is to use n-minute time intervals where n is some integer and average the amount of points in that interval. We choose the value of n to be just large enough to incorporate enough points so that the average won't fluctuate too drastically but small enough to notice some smooth trends in the points distributions. We take the average of the total points scored in the first n-minute time interval, then we take the average of the total points scored in the second n-minute time interval by shifting over one minute, and continue this process until we no longer can. So, for example, a team which scores a total of 20 points in the first 8-minute interval (choosing n=8 obviously) would have averaged 2.5 points/minute for the first 8-minute interval. Examples are shown in FIG. 12 for n-minute time intervals where n=1, 2, 4, 8 and as we can see the functional relationships have better continuity as we increase the value of n, but we also notice the sharp edges of the lines which were formed by simply connecting the dots.

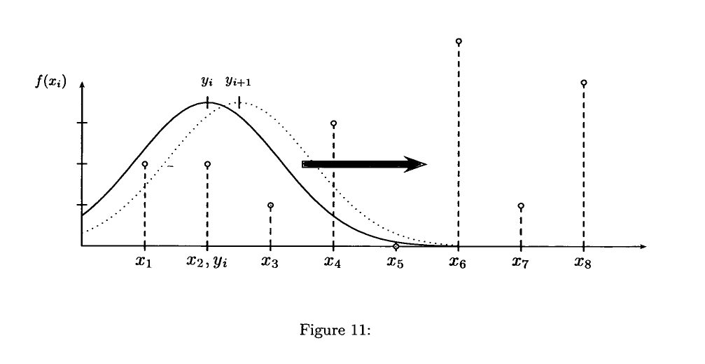

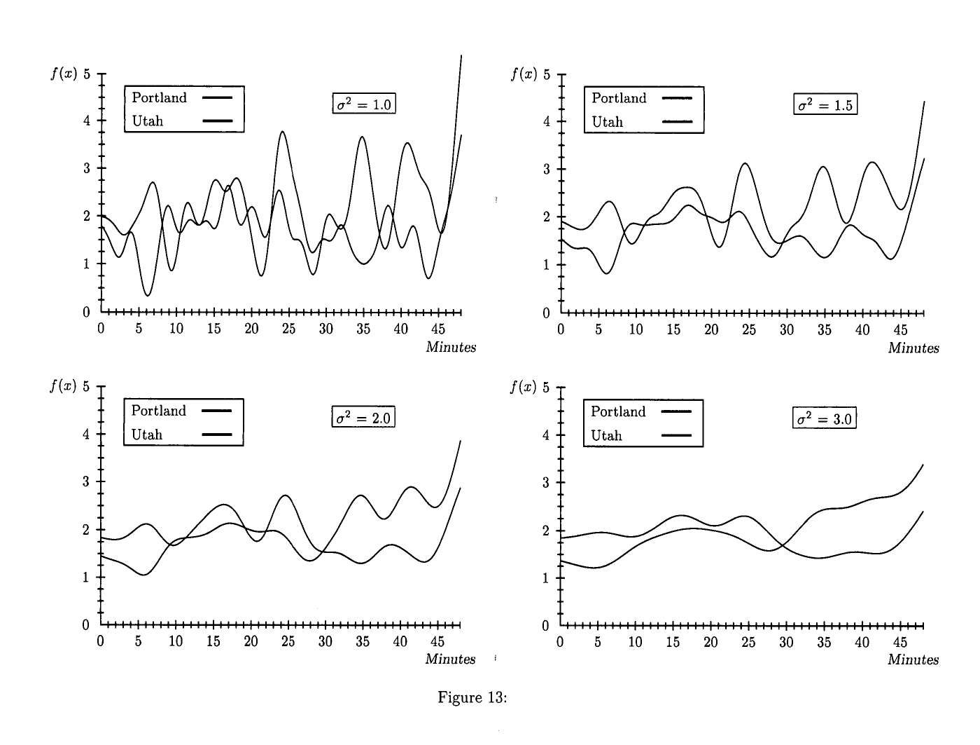

The technique explained above was a special case of data averaging where a weighting function is used to average the data. The particular weighting function that was used in that example is called a square step function. Alternatively, we can form an even smoother functional relationship between the data points by using a Gaussian function as our weighting function to average the raw data points. The idea is nicely illustrated in FIG. 11. The raw data points are expressed as the function f(xₙ) of the discrete variable xₙ where n=1, 2, . . . , 48 so that f(x₁)=2, f(x₂)=2, f(x₃)=1, f(x₄)=3 and so on. Those data points are then averaged using the Gaussian weighting function given by
w(xₙ−yₘ)=exp^{-x}^{ₙ}^{-y}^{ₘ}⁾^{²}^{/2σ}^{²}
where σ is the standard deviation of the Gaussian function (which is an adjustable parameter) and the function is offset by the amount xᵢ. A new averaged function g(yₘ) is expressed as

$$\begin{matrix}g ( {y}_{m} ) = \frac{{\sum }_{n = 1}^{48} f ( {x}_{n} ) w ( {x}_{n} - {y}_{m} )}{{\sum }_{n = 1}^{48} w ( {x}_{n } - {y}_{m} )} \\ = \frac{{\sum }_{n = 1}^{48} f ( {x}_{n} ) {exp}^{- {( {x}_{n} - {y}_{m} )}^{2} / 2 {σ}^{2}}}{{\sum }_{n = 1}^{48} w ( {x}_{n} - {y}_{m} )}\end{matrix}$$

where m≧48. The greater the value of the index m the more averaged data points we have and the better the continuity of the function g(yₘ). In FIG. 13 it is shown that as the value of σ² increases the functions become less sensitive to volatile fluctuations in the data thereby producing smoother curves. However, if we increase the value of σ² beyond 3.0 we begin to lose sight of any fluctuations in the scoring productivity.

These examples are only for the single game case and can be extended to multiple games and even multiple seasons as well. Using EASI we can generate the same distributions by accumulating the statistics exclusively for as many games as we wish. By exclusively we mean keeping the statistics separated to the minute level and combining them only if they fall within the same minute. Therefore we would simply add all of the points in the n^{th}-minute of each of the games and then average the total points scored. There is also an inclusive analysis which combines statistics from disjoint minute intervals or time segments of a game by forming the union from those segments of time. We may want to form the union from disjoint time periods such as halves or quarters of games to determine if there are any consistencies or trends at those levels. So although each quarter of a game is technically a different quarter we can treat each one as though they were the same by forming the union. This is useful when-trying to analyze individual players since they usually don't play the entire game. In this situation we can treat disjoint segments of time that a player is in the game as identical segments.

Thus far we have only mentioned points, but of course we can generate the same statistical distributions and probability densities for all of the other statistics too. We can also do this for statistical quantities like field goal percentage, three point percentage, and free throw percentage. Other derived quantities include assist-points ratios, steals-possession ratios, offensive rebounds-possession ratios, a player's field goal attempts to team possession ratio, a team's and player's three point field goal attempts to ordinary field goal attempts and any other pertinent statistical derivatives which can be calculated using EASI. Ultimately all of these statistical distributions and probability densities can be used to better understand how the game evolves and models for the simulation. Probabilities densities are formed by simply normalizing the generated functions by scaling the entire function such that the highest value of the function is 1.

To examine the statistical phenomena in distributional format, we construct (prepare) histograms with twelve (12) bins which are binned according to the number of minutes there are in a quarter giving forty-eight (48) total bins. This seems to be the most suitable choice of binning since the game phenomena usually occur on the order of a few times every minute. Two good examples of events this would work well for would be for timeouts and standard statistical events within a 24 s shot-clock context. Each time a timeout is called we increment the number of counts that are in the bin representing the minute the called. So if a timeout was called in with 7:30 left in the first quarter the a count would be added to bin # 5 of the first quarter. If we do this for all games that are played a very nice distribution should emerge from which we can model timeout calling. These histograms are not restricted to only timeouts and regular statistics, but can also be setup for derived events. As a matter of fact we can set up nice histograms showing the number a games with a particular score.

The shot-clock context will help us model when during a possession different event types typically occur. In this case histograms would still be used but would be binned with twenty-four (24) bins for the number of seconds there are on the shot-clock. We could then see figure out field goal percentage as a function-of time on the shot clock for any team. Or we could see the distribution of field goal attempts taken during a possession. Field goal attempts happening within the first five (5) seconds of a possession would give us an idea of the fast-break opportunities a team is getting. Comparing that quantity with the players who are in the game from the player tracking chart we could determine which set of players are best for taking advantage of fast-break opportunities. Next, we give a formal description of how to reject events from the analysis.

7.4.3 Statistical Breakdown Methods

The most effective way to analyze the data in the form of quantized events is through the use of statistical breakdown methods. These techniques will allow anyone with a general familiarity to meticulously dissect or breakdown a game, season, or player's career. Using the event sieve process for rejecting events as described earlier we can disregard the statistical implication of particular elements (seasonal/game/event) that do not possess certain properties and characteristics which fall under a prescribed set of screening criteria.

Statistical reductions can be made by subjecting the available data to restrictions of the following form(s):
Any subset or collection of seasonal elements, further restricted by . . .
Any subset or collection of game elements, again further restricted by . . .
Any subset or collection of event elements where . . .
The most general set or collection of elements (season/game/event) are given by the following:
   The set of no elements, or . . .
   The entire set of elements (no restriction whatsoever), or . . .
   Any other possible collection of elements which can be chosen from selection techniques and screening criteria that are:
      Sequential, consecutive, random in nature, or . . .
      Based on certain statistical properties, qualities, and characteristics that individual elements may or may not possess, or . . .
      Based on statistically, analytically, or functionally derived properties, qualities, and characteristics that a particular group of elements may or may not possess.

Let us elaborate more on the generalized selection techniques and screening criteria in which we have at our disposal. Within the data structure hierarchy we can eliminate any seasonal node or game node thereby removing all of the game nodes and event elements which reside in that branch. We can also leave all of the nodes in place so that we have access to all of the event elements and eliminate events strictly based on their phenomenological properties and statistical implications. This means we can sift out events according to their temporal properties, according to their type (jumpball, steal, foul, rebound, etc.), according to which players were involved in the event, according to which players were active in the game, or finally according to the statistical implications governing the events.

The very last item on the list specifies statistically derived qualities which can be thought of as qualities or traits determined from at least two or more events. We can form numerous quantities of interest by taking the average of some statistic with respect to a different statistic and also by forming percentages for any segments of time or any number of events. We can also use the phenomenological concepts of positions, performance, and team efficiency as well to exclude seasons, games, or even quarters from our analysis. Many calculations are made for an analyzable entity. This is a very wide range of entities ranging from a player, a group of players, a team, a group of teams, a situation, the union of several situations, an interval of time during a sport contest, an interval of time spanning multiple sport contests, where there may be multiple disjoint intervals.

From the previous section we can use statistical distributions, functional relationships or probability densities for the same purpose. We can even look at analytical concepts such as derivatives (literal analytic meaning) and integrals to look at whether certain trends are increasing or decreasing and whether certain cumulative values are in excess of a prescribed value and then use these properties to accept or reject events. It is obvious that these methods for determining various statistically derived quantities require that quarters, games, and seasons to be played out in their entirety.

7.5 Monte Carlo Simulation of Games and Seasons

A simulation is an excellent tool for probing hypothetical situations which are not feasible under ordinary circumstances. It provides us with a virtual game environment from which we may ascertain a wide variety of game scenarios that range from general situations to non-routine and completely unexpected or unlikely situations. Minor adjustments and tweaks can be made to a team's offense or defense in search of avenues that could potentially optimize a team's performance. The effects of player trade negotiations can be assessed before an actual trade has been executed. Or perhaps we can use the simulation in draft situations to determine which prospective players will be the best match for a team. Irregardless of the approach we can study the game in more detail and be better prepared for any kind of situation which is encountered.

The simulation, or virtual sport contest, is similar to the original process of collecting real events at a game except now the events are generated fictitiously using computerized Monte Carlo techniques. It uses the statistical distributions and probability densities as models to randomly generate which event will take place and all of its respective characteristics according to the current game conditions. Some interactivity with the user may also be incorporated into the simulation by allowing the user control over when timeouts are called and how the players are substituted in for each other. In addition, other parameters can be controlled, for example by limiting the amount of field goal attempts a player takes (in terms of limiting their field goal attempt percentage relative to the team). We can also specify how much time a player spends in the game along with which players (on average) and during specified situations.

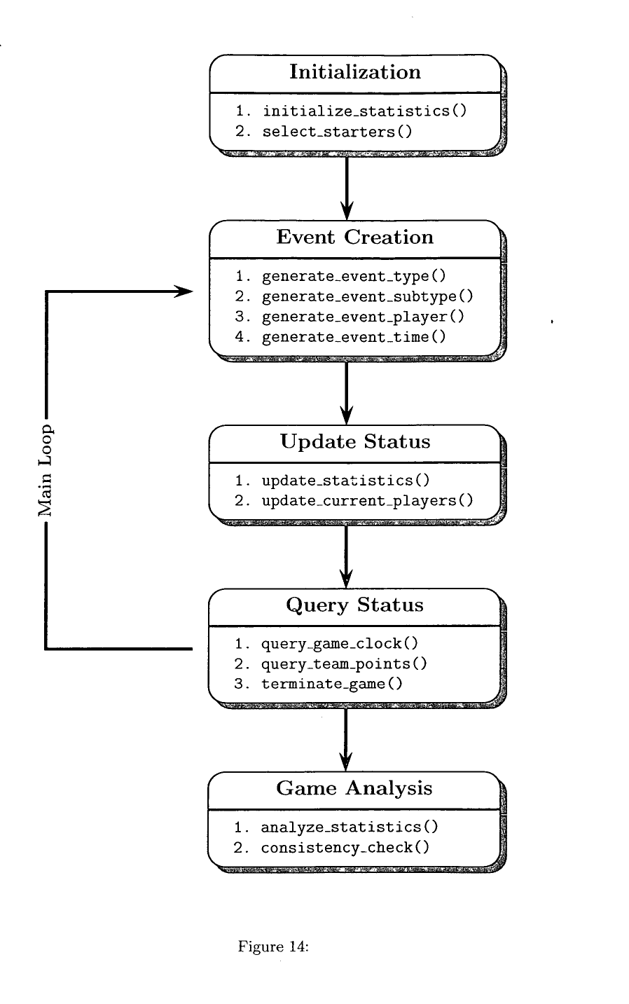

Here an “ad hoc” version of the proposed simulation is presented as a schematic outlining a step-by-step process for the generation of events. The schematic can be seen in FIG. 14. First, all statistics are properly initialized and all control parameters are given before the game has started. Basically each of the player's and both team's real-time game statistics are initialized to zero and any progressive statistics like seasonal statistics are assigned their respective cumulative values. After a successful initialization, the starters are selected from models describing most likely combinations of players expected to start a game or through user intervention in which the user can provide the starters manually. Technically, the substitution of starters is considered to be the beginning of the game although the clock has not officially started. Because the selection of starters (for both teams) is considered an event we must update the current game status which keeps track of the players currently in the game.

We now enter the main loop which is the engine for all of the event generation. The very first event is always a jumpball event in which two players jump to determine which team gets the very first possession. After this the main loop continues to generate events until all of the game time has expired in which case it queries the scores to determine if additional overtime periods are necessary. Otherwise the virtual sport contest is terminated. While in the midst of play each team can elect to call a timeout (if timeouts still remain) while it has possession and subsequently a substitution of players can be made otherwise normal play is carried out. Normal play generally signifies an event which happens during the continuous flow of game action. Events such as fouls or out-of-bounds are considered to be normal play events even though they cause the game clock to be stopped.

The simulation does not operate off of a realistic clock as one might expect. Instead, for each event type there is a statistical distribution in the form of histogram which we can use as a models (described in more detail in the Generation of Statistical Probabilities Section) to describe the relative time (in seconds) to the shot-clock that an event normally happens during a possession. There is an additional model for timeouts that would describe the relative time (in minutes, and perhaps half-minutes) to the game clock that the timeouts usually happen since these events are limited and thus don't happen as frequently. We can form more refined distributions by taking into account which players are in the game and what quarter or minute the game is in. So once the time of the event has been satisfactorily determined we subtract that amount of time from the “pseudo-clock”. One nuance that also needs to be compensated for is the time between the made field goal attempt and the inbounding of the ball by the opposing team as it is typical for a few seconds to elapse off the game clock before the new shot-clock is started.

The level of precision and accuracy of the program is administered by the person actively using the simulation software and it is their discretion as to which models would be-consulted by the software. Any models that are used should be formed from realistic data especially when trying to derive fairly complex dynamical statistical distributions. The user should be comfortable with the models used and completely understand the ramifications or consequences associated with using any particular model. Simple nondynamical models can be used with little or no justification again so long as the user is comfortable with their choice. The most generic model for the scoring of points would entail flat averages for the field goal attempt percentage and a percentage of shots that are either 3-pointers or only worth two (2) points for that team. That scenario would be representative of the entire team leaving out any of the game dynamics. As more complexity is desired more game dynamics can be incorporated, but one must be careful that none of the models should interfere with each other producing bogus results.

Of all of the events the two most difficult, although not impossible, to model are the calling of timeouts and the substitution of players which can only happen during dead-ball situations. These are situational decisions that are made primarily based on a coach's sentiments at some point in the game. So in this instance we have certain indicators which we need to look for. Some of these indicators include increasing opponent's momentum, poor team performance, a necessary and legitimate break in action for rest, a need to substitute players, etc. This can be done interactively, but this approach would slow down the original intended process.

A virtual sport season can also be simulated by putting together multiple virtual sport contests. Similarly multiple virtual sport seasons can be simulated.

7.6 Adaptation to Other Sports

With some minor adjustments and tweaks all of the above methods can be applied to football, baseball, hockey, golf, soccer, etc. With the awkward way the scoring is done in football a better choice would be to use yardage as a consistent statistic to compute the positions and performance gauges. The event data structure would need to be tailored to accommodate the statistics used in football, but the general structure would be the same. For each play the number of yards made along with the type of play and the time the play happened relative to the game clock would be recorded as usual. Also we would record the relative time to play clock and perhaps even the time the play start, the time the play ended as well as precisely when a particular event happened during a play, for example a fumble. Basic play types are either pass, or run, and special teams plays such as kickoff, extra point, punt, and field goal attempts. Certainly there are many subtypes for all of these plays when we include general play patterns. We also record the down and associated yardage to make the first down. Substitution of players is done in exactly the same way and the player tracking chart might distinguish the difference between offensive, defensive, and special teams players by using different color bars.

In baseball, we could instill a pseudo-clock which would be started at the beginning of the game and also when the pitcher threw first pitch. In this way we could give the events a relative time to the game and study the events as a function of time. For each event all of the known statistics would be recorded, for example, strikes (swinging), ball, hits, fouls, strikeouts (swinging), runs, and outs in the current inning. Different types of hits like home runs, bloop singles, bunts would also be noted for a complete analytical treatment of the games.

7.7 Various Applications

This system has a wide variety of applications which fall outside of just the basketball league and the teams. The information and statistical breakdown would be beneficial to sports channels (ESPN) for analysts, commentators, and viewers. Complex statistical breakdowns could be instantaneously computed at the touch of a few keystrokes and not maintained in logbooks or remembered by statisticians. Gaming companies who would have access to the database could also do highly involved statistical analysis to determine according to their own expert analysis which teams have the best probability of winning and the corresponding spread. Video game companies who try to imitate the game as best as possible as far as the game dynamics would benefit enormously from this information. Fantasy football leagues would have access to much more detailed information and analysis. Ratings and polls, especially the BCS, could use this system to scientifically analyze, research, and determine with certainty which teams are in fact the best.

What is claimed is:

1. A method for acquiring and analyzing phenomenological and statistical data regarding a sport contest, comprising:
identifying a plurality of discrete events that happen during the sport contest;
recording onto computer readable media, as a quantized event, the following attributes for each such event:
phenomenological data describing a characteristic of the event;
sequential data specifying an ordering amongst events taking place during the sport contest; and
performing an analysis on a collection of recorded quantized events by processing said collection to obtain a statistical result for said collection comprising the following steps:
resolving an attribute for the quantized event from said collection; and
determining the statistical result for the said collection according to the attribute for the quantized event.

2. The method of claim 1, wherein the sequential data is recorded as a time from a clock that is maintained in relation to the sport contest.

3. The method of claim 2, wherein the time includes an unambiguous time and the clock includes an uninterruptible clock that is maintained in relation to the sport contest.

4. The method of claim 3, wherein the unambiguous time is the time recorded from the uninterruptible clock that has elapsed since the occurrence of an event in relation to the sport contest.

5. The method of claim 4, wherein the event is the inception of the sport contest.

6. The method of claim 2, wherein the time includes an ambiguous time and the clock includes a resettable clock that is maintained in relation to the sport contest.

7. The method of claim 6, wherein the ambiguous time is the time recorded from the resettable clock that has elapsed since the occurrence of an event in relation to the sport contest.

8. The method of claim 1, wherein said collection of quantized events are stored in a searchable database for subsequent retrieval and further analysis.

9. The method of claim 8, wherein said collection of quantized events are obtained over multiple sport contests, said collection being further characterized by the particular sport contest in which the quantized event occurred, and the analysis being further comprised of processing said collection of quantized events relative to an attribute of the particular sport contest to obtain a statistical result for said collection.

10. The method of claim 9, wherein the multiple sport contests take place over multiple sport seasons, said collection being further characterized by the particular sport season in which the particular sport contest occurred, and the analysis being further comprised of processing said collection of quantized events relative to an attribute of the particular sport season to obtain a statistical result for said collection.

11. A method for simulating a sport contest phenomenologically and statistically as a virtual sport contest, the method comprising the computer-implemented steps of:
generating a plurality of fictitious events for the virtual sport contest;
generating the following attributes, as a quantized event, for each such fictitious event:
phenomenological data describing a characteristic of the fictitious event;
sequential data specifying an ordering amongst fictitious events; and
performing an analysis on a collection of fictitious events by processing said collection to obtain a statistical result for said collection comprising the following steps:
resolving an attribute for a fictitious event from said collection; and
determining the statistical result for the said collection according to the attribute for the fictitious event.

12. The method of claim 11, wherein the sequential data is generated as a time in the virtual sport contest.

13. The method of claim 12, wherein the time generated includes an unambiguous time of the virtual sport contest.

14. The method of claim 13, wherein the unambiguous time is a time relative to the unambiguous time of another event, past or future.

15. The method of claim 14, wherein the relative time to the unambiguous time of the other fictitious event, past or future, is determined by statistical models describing and predicting the relative time between the fictitious event, past or future, and the current fictitious event.

16. The method of claim 11, wherein the time generated includes an ambiguous time in the virtual sport contest.

17. The method of claim 16, wherein the ambiguous time is determined by statistical models describing and predicting the ambiguous time for a fictitious event having particular attributes.

18. The method of claim 11, wherein the collection of fictitious events are stored in a searchable database for subsequent retrieval and further analysis.

19. The method of claim 18, wherein the collection of fictitious events are obtained by generating multiple virtual sport contests, said collection being further characterized by the particular virtual sport contest in which the fictitious event occurred, and the analysis being further comprised of processing said collection of fictitious events relative to an attribute of the particular virtual sport contest to obtain a statistical result for said collection.

20. The method of claim 19, wherein the multiple sport contests are generated over multiple virtual sport seasons, said collection of fictitious events being further characterized by the particular virtual sport season in which the virtual sport contest occurred, and the analysis being further comprised of processing said collection of fictitious events relative to an attribute of the particular virtual sport season to obtain a statistical result for said collection.
